(19) United States
(12) Patent Application Publication
(10) Pub. No.: US 2001/0038183 A1
(43) Pub. Date: Nov. 8, 2001

(54) Adjustment device, particularly for a snowboard binding

(76) Inventors: Roberto Gorza, Feltre (IT); Flavio Frigo, Vicenza (IT); Pino Tessari, Altivole (IT)

Correspondence Address: MODIANO & ASSOCIATI, Via Meravigli, 16, MILANO, 20123, IT

(21) Appl. No.: 09/730,584

(22) Filed: Dec. 7, 2000

(30) Foreign Application Priority Data
Dec. 10, 1999 (IT) TV99A000139

(51) Int. Cl. B62B 9/04; B62B 13/00; B62B 15/00; B62B 17/00; B62B 19/00; B62M 27/00

(52) U.S. Cl. 280/14.24

(57) ABSTRACT

An angular adjustment device particularly for a snowboard binding, comprising a toothed disk which is rigidly connected to the snowboard and a supporting base for a shoe and is constituted by a plate which is slidingly associated with the base. The plate selectively interacts with means for connection to the toothed disk which allow the connection or disconnection of the disk with respect to a complementarily toothed seat formed below the base.

### BACKGROUND OF THE INVENTION

The present invention relates to an adjustment device, particularly for a snowboard binding.

Snowboarding is characterized by various techniques that can be used by the skier, including jumps and various freestyle maneuvers, slalom, and pure speed; in order to correctly perform each one of these techniques, the user has to assume a body posture which has a given angle with respect to the longitudinal axis of the board.

U.S. Pat. No. 5,028,068 discloses a device for selectively and pivotally positioning a ski binding on a snowboard, comprising a first plate which supports the boot and is arranged above a second circular plate which is perimetrically provided with a groove.

The second circular plate is rotatably connected to a third plate which is in turn rigidly connected to the board; the second circular plate has, at the groove, a wire which is wound thereat and can be tensioned by means of a lever.

The actuation of the lever allows the engagement and disengagement of the cord with respect to the second circular plate, allowing the user to vary the angular position of the binding with respect to the longitudinal axis of the board.

However, this solution has drawbacks; during snowboarding, the binding and therefore the board can be subjected to many torsional stresses which may not be contrasted effectively by the tension of the wire on the second circular plate; particularly upon impact with the snow after a jump, the binding is subjected to a sudden and very intense torsional stress which is unlikely to be contrasted by the friction between the two facing surfaces of the first plate and the second plate, which are smooth.

Moreover, the wire tensioning lever is located separately and at a distance from said binding; accordingly, the lever can easily disengage during sports practice because of accidental impacts with stones, or other objects, or due to the snow itself.

Moreover, part of the wire is exposed to possible accidental impacts and can be torn or weakened, thus compromising the use of the binding.

In such cases, the user would lose control of the board, which would be difficult to control. Moreover, snow or water can deposit between the wire and the second circular plate, further reducing the friction between the two smooth facing surfaces of the first plate and the second plate and accordingly reducing the overall securing force of the lever.

All that is dangerous for the user who, because of the possible lack of rigid engagement of the binding with the board, may suffer severe problems with his or her legs in case of a fall.

U.S. Pat. No. 5,044,654 discloses a binding which can be turned about its own vertical axis. Six spaced holes are provided therein in order to accommodate a corresponding number of screws suitable to allow to fix it to the board in a given angular position which is preset by the user. The angular position can be changed by unscrewing the screws and repositioning them so that the binding is rotated by the chosen angle.

The binding further has a safety system for rapid release of the boot from the board which is substantially composed of a hub on which appropriately shaped seats are formed perimetrically in order to accommodate a ball with a forcing action provided by means of a spring.

However, this solution has drawbacks; in order to vary the angular position of the binding with respect to the snowboard, the user has to remove his foot from the binding and, by means of an appropriate tool, unscrew the fixing screws, reposition the binding in the chosen position and reconnect it to the board.

The above-described operations, however, require considerable time and force the user to be always equipped with at least one tool.

Moreover, in order to perform the adjustment, the user has to remove his or her foot from the binding and therefore cannot immediately perceive the set degree of adjustment.

Moreover, due to the scarce attention paid by the user to these operations in his eagerness to be on the ski slopes, the screws might be fixed inaccurately to the board, with consequent dangers of separation or poor control of the board during sports practice.

It is also known to use a snowboard binding which is fixed to the board by means of a disk which is rigidly connected thereto by means of screws.

Inclined planes protrude toward the board below the disk, are arranged perimetrically and interact with complementarily shaped planes formed at an adapted disk containment seat which is formed in the binding.

By appropriately tensioning the screws, the disk moves toward the board until its inclined planes interact with the complementarily shaped planes formed on the binding, thus locking the disk and the binding to the board in a given position.

It is known to replace said inclined planes with pairs of sets of teeth which are also inclined and arranged on the disk and on the binding.

In this manner, the engagement and disengagement of the screws allows the disk to rise until the pairs of sets of teeth are mutually disengaged although the disk remains connected to the board.

By rising, the disk allows to turn the binding, which can be arranged in the chosen angular position.

It is thus possible to obtain a range of positions which are mutually different but limited in their number by the size of the teeth that constitute the pairs of sets of teeth.

The use of this conventional binding, however, has other drawbacks; the user must remove his gloves, remove the foot from the binding, be equipped with a screwdriver or appropriate wrench in order to disengage the screws, turn the binding with his hands into the position that approximates the intended one, and tighten the assembly.

This operation is too long and troublesome to perform directly on the slope in order to change the angular position according to specific requirements.

Another solution that is used is known as “baseless” and has a binding which is constituted by two separate half-shells which are interconnected by a rear band, each half-shell being fixed to the board by means of screws which are accommodated in adapted slots formed in the flat part of the half-shells.

Such conventional binding has the drawback of an angular adjustment which is limited by the dimensions of the slots.

EP-A-0 761 261 discloses an angular adjustment device, for a snowboard binding, with which a disk and a shoe resting base are rigidly connected, the binding being constituted by engagement means which are associated with the base and selectively interact with grip means formed on the disk.

The disk has a set of teeth which interacts with an additional set of teeth provided in the engagement means, so that the mutual locking of the two elements occurs by way of the interaction between the two sets of teeth; although this solution is valid as regards the problem of achieving angular adjustment of the binding with respect to the board, drawbacks might occur in relation to any deformations caused by continuous use of the device or by accidental impacts or any temperature changes to which the binding is subjected, all of which can alter the operation of the device.

Moreover, the device requires, for its activation, a precise arrangement of the various mutually interacting elements, and this forces the user to make several attempts to achieve the precise position for locking the binding which might lead, due to carelessness on the part of the user, to possible “false” lockings of the bindings, with consequent possible danger for the safety of the user during sports practice.

U.S. Pat. No. 5,947,488 discloses an angular adjustment device for a snowboard binding, comprising a disk which is rigidly connected to the snowboard and a supporting base for a shoe.

Such device is constituted by first engagement means associated with the base and selectively interacting, by way of second release means which can be actuated by the user, with third grip means which are rigidly coupled to the disk.

Although this solution is valid as regards the problem of achieving angular adjustment of the binding with respect to the board, it too is constituted by a set of complicated mechanisms which are composed of a considerable number of mechanical elements which make the device expensive and complicated to manufacture and to assemble.

All this also leads to a natural predisposition to possible breakage or malfunctions, especially in view of the difficult climate conditions in which it is used.

### SUMMARY OF THE INVENTION

The aim of the present invention is to solve the above-mentioned problems, eliminating the drawbacks of the cited prior art, by providing a device which is structurally simple and cheap to manufacture and allows to rapidly achieve a chosen and easy angular adjustment of the binding with respect to the longitudinal axis of the board, the adjustment being stable during sports practice, so as to increase the degree of safety for the user.

Within this aim, an object of the present invention is to provide a device in which the angular position assumed by the binding can be locked in an optimum and safe way without false lockings.

Another object is to provide a device in which the preset adjustment of the angle cannot be modified by any presence of snow or ice or any temperature variations.

Another object is to provide a device in which the stress that the user can apply in order to activate the device is low with respect to the perfect locking that can be achieved for the binding.

Another object is to provide a device which allows the user to achieve the intended adjustment very easily and rapidly without resorting to particular tools.

Another object is to provide a device which is structurally compact and free from accidental openings during sports practice.

Another object is to provide a device which ensures that the binding remains locked to the board during angle adjustment, increasing safety for the user.

Another object is to provide a device whose volume and weight are negligible for the user during the practice of said sports.

Another object is to provide a device which is reliable and safe in use and can be manufactured at low costs with conventional machines and systems.

These and other objects which will become better apparent hereinafter are achieved by an angular adjustment device particularly for a snowboard binding, comprising a toothed disk which is rigidly connected to the snowboard and a supporting base for a shoe, characterized in that it is constituted by a plate which is slidingly associated with the base and selectively interacts with means for connection to the toothed disk which allow the connection or disconnection of the toothed disk with respect to a complementarily toothed seat formed below the base.

### BRIEF DESCRIPTION OF THE DRAWINGS

Further characteristics and advantages of the present invention will become better apparent from the following detailed description of an embodiment thereof, illustrated only by way of non-limitative example in the accompanying drawings, wherein:

FIG. 1 is a perspective view of an angular adjustment device which is associated with a snowboard binding, with the adjustment plate in a first position, which allows to release the device;

FIG. 2 is a perspective view of the angular adjustment device, with the adjustment plate in a second intermediate position;

FIG. 3 is a sectional side view of the angular adjustment device, with the supporting base rigidly coupled to the toothed disk;

FIG. 4 is a sectional side view of the angular adjustment device in the second position, with the supporting base raised with respect to the toothed disk;

FIG. 5 is a view of the adjustment plate;

FIG. 6 is a view of a second embodiment of the invention;

FIG. 7 is a view, similar to FIG. 3, of the embodiment of FIG. 6.

### DESCRIPTION OF THE PREFERRED EMBODIMENTS

With reference to the figures, the reference numeral 1 designates an angular adjustment device, particularly for a snowboard binding 2, comprising a toothed disk 3 which is rigidly coupled to a snowboard, designated by the reference numeral 4, by means of first screws 5 which pass through adapted first slots 6 which allow to adjust the position of the toothed disk 3 along the longitudinal axis of board 4.

The toothed disk 3, which is preferably frustum-shaped, has a lateral edge 7 which is oblique and orientated upward and is provided with a set of teeth on its lateral surface.

In a central position with respect to the toothed disk 3, there is a first hole, designated by the reference numeral 8, for the removable connection of a supporting base 9 for a shoe.

The base 9 has a first lateral raised portion 10a and a second lateral raised portion 10b, which protrude vertically so as to block the lateral movement of the shoe.

A first end 11a and a second end 11b of a rear flap 12 are associated with said first and second lateral raised portions 10a and 10b, by way of first and second connection means 13a and 13b which are constituted by bolts and nuts.

The rear flap 12, which is arranged in a vertical position, is adapted to support the rear part of the shoe so as to block its rearward movement.

A flat plate 15 is associated, preferably in a central region, designated by the reference numeral 14, of base 9 and is laterally provided with a tab 16 which protrudes vertically upward, proximate to the first lateral raised portion 10a.

The plate 15 is associated with the base 9 so that it can slide with respect to said base, with a translatory motion or with a rotary motion, as in the embodiment shown by way of example in the accompanying drawings.

The plate 15, which is preferably triangular, is in fact rotatably connected to the base 9, at the vertex that is advantageously, but not exclusively, directed toward the rear flap 12, by means of a second screw 17, the stem of said second screw passing through an adapted second hole, which is designated by the reference numeral 18 and is formed in the plate 15.

Advantageously the plate 15 has, at the opposite end with respect to the second hole 18, a second slot, designated by the reference numeral 19, which is shaped like a circular arc which is preferably centered at the second hole 18.

A sliding pin 20 is advantageously arranged in the second slot 19 and is fixed, at one end, to the base 9 so as to constitute, together with the second slot 19, a sliding guide for the partial rotation of the plate 15 with respect to the base 9.

The plate 15 has, advantageously in an intermediate position between the second hole 18 and the second slot 19, an opening designated by the reference numeral 21; such opening is conveniently shaped so as to have a third slot 22, which is shaped like a circular arc and is also centered preferably proximate to the second hole 18, and a connected third hole, designated by the reference numeral 23, which is arranged toward said first lateral raised portion 10a.

Connection means can be arranged in the opening 21 and are constituted by a third screw, designated by the reference numeral 24, which selectively interacts with the plate 15.

The third screw 24 has a head 25, whose dimensions are such that it can pass through the third hole 23 of the opening 21, and a stem 26, whose diameter is such that it can slide within the third slot 22.

The end of the shaft 26 of said third screw 24 is detachably connected, for example screwed, onto said first complementarily threaded hole 8 formed in said toothed disk 3.

Depending on the position of said plate 15, the third screw 24 allows to connect or not connect the lateral edge 7 of said toothed disk 3 to a complementarily toothed seat, designated by the reference numeral 27, which is formed below the base 9 in a region below the plate 15.

The distance between the head 25 and the upper surface of the toothed disk 3 must preferably be approximately equal to the sum of the thicknesses of the plate 15 and of the base 9, at the seat 27.

The uncoupling of the toothed disk 3 from the complementarily shaped seat 27 must be achieved with a vertical movement which is not greater than the height of the plate 15.

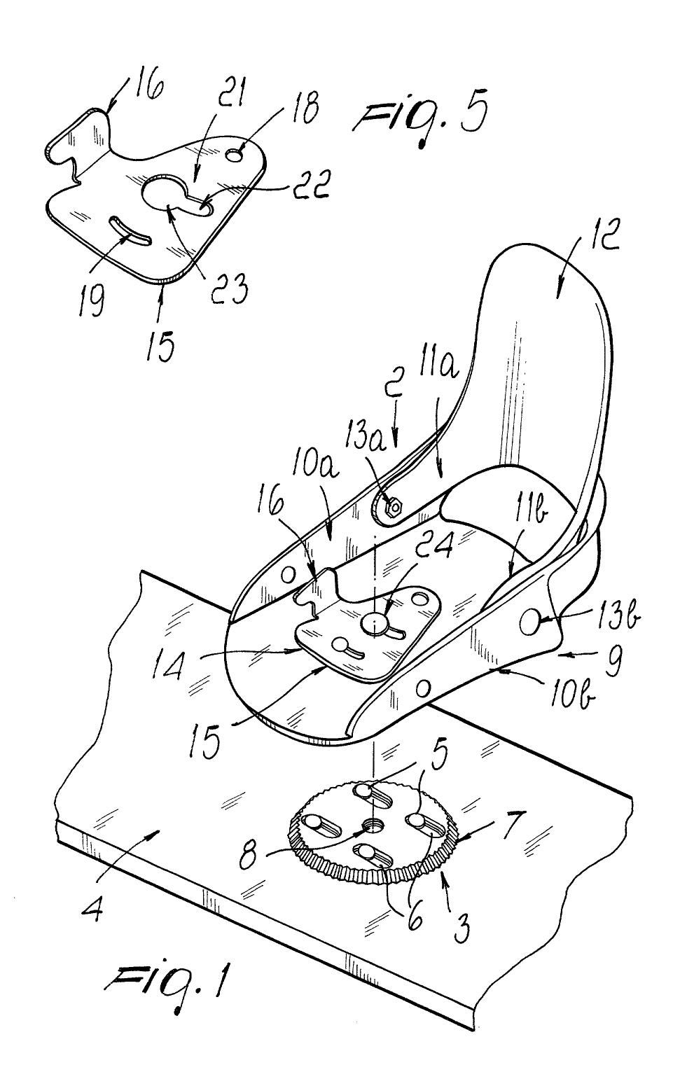

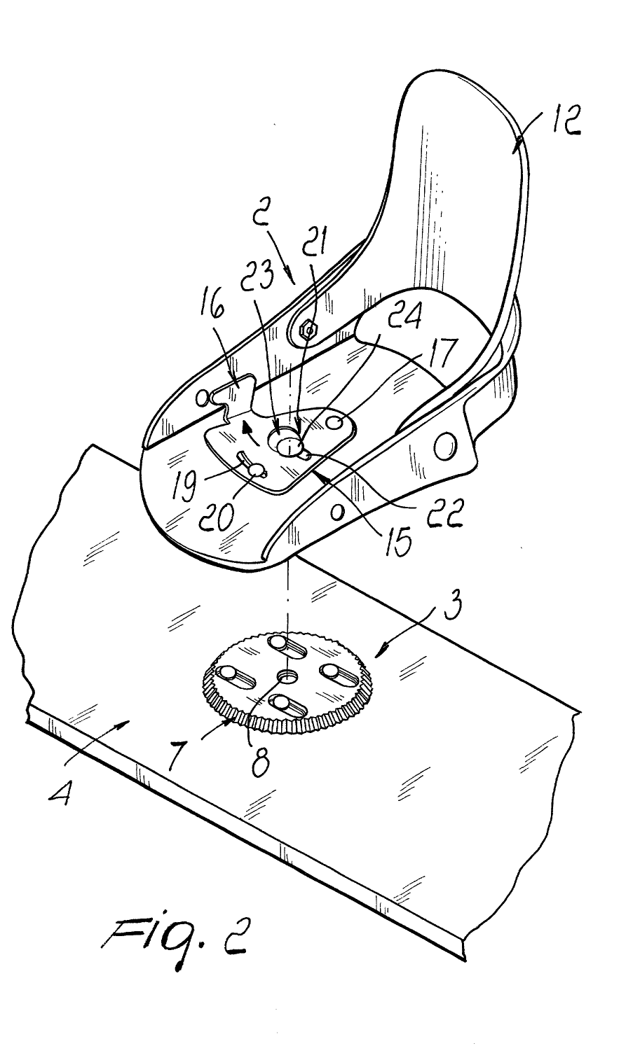

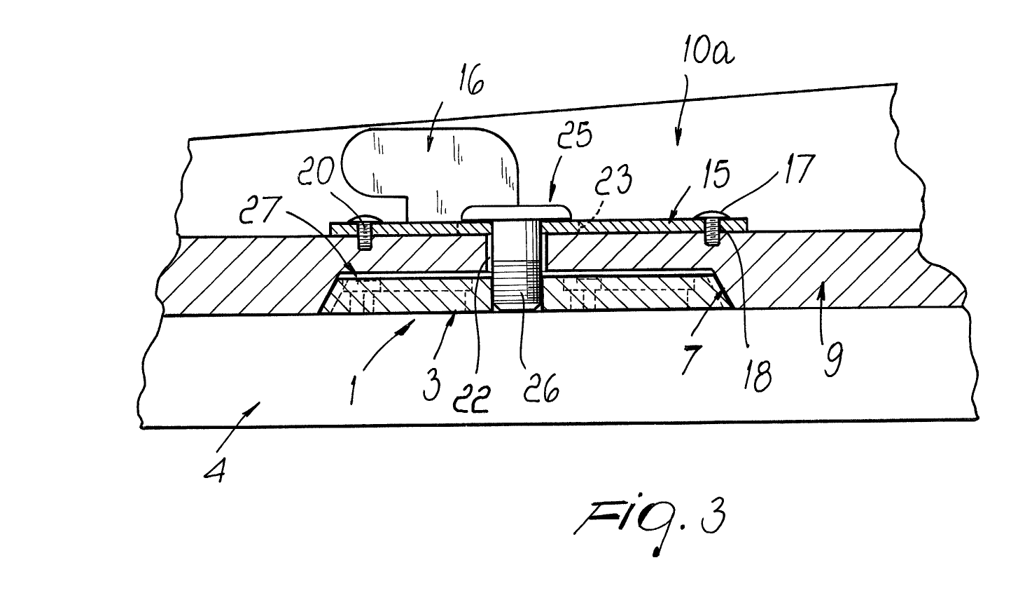

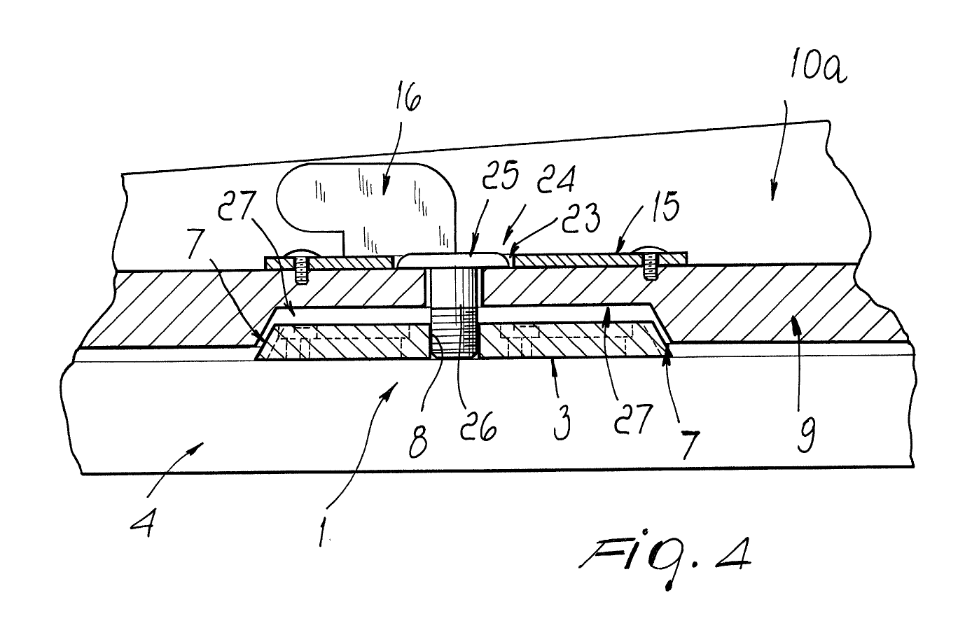

Operation is thus as follows: with reference to FIGS. 1, 2 and 3, the adjustment device 1 is locked when the tab 16 is advantageously adjacent to said lateral raised portion 10a, so as to not prevent the resting of the sole of the shoe.

With the tab 16 in this position, the stem 26 of the third screw 24 is in the third slot 22 and the corresponding head 25 rests on the upper surface of the plate 15, thus preventing, owing to the thicknesses involved, the lifting of the base 9 with respect to the toothed disk 3.

In this position, the toothed lateral edge 7 of the disk 3 is associated with the complementarily shaped seat 27 so as to prevent any rotation of the base 9 with respect to the snowboard 4.

By acting on the tab 16 toward the second lateral raised portion 10b, the plate 15 is turned so as to place the head 25 of the third screw 24 at the third hole 23 which belongs to the opening 21, as shown in FIGS. 1 and 4.

Since the head 25 is smaller than the third hole 23, it can rest on the upper surface of the underlying base 9, thus allowing the spacing of the toothed disk 3 from the corresponding seat 27.

With the temporary removal of the coupling that prevented the rotation of the adjustment device 1 with respect to the board 4, it is thus possible to perform a quick angular adjustment of the snowboard binding 2.

Once adjustment has been performed, the device 1 is locked easily by lowering the base 9 until contact with the board 4 is achieved and by then turning the tab 16 into the original position.

It has thus been observed that the invention has achieved the intended aim and objects, a device having been provided which is simple and cheap to manufacture and allows to rapidly achieve a chosen and easy angular adjustment of the binding with respect to the longitudinal axis of the board, said adjustment being stable during sports practice, thus increasing the degree of safety for the user.

In order to further increase safety, the adjustment device does not allow to insert the shoe in the binding if the adjustment plate is not in the correct locking position; by way of the presence of the tab 16, insertion is in fact allowed only when said tab is adjacent to the lateral raised portion 10a.

The device according to the invention is susceptible of numerous modifications and variations, within the scope of the appended claims.

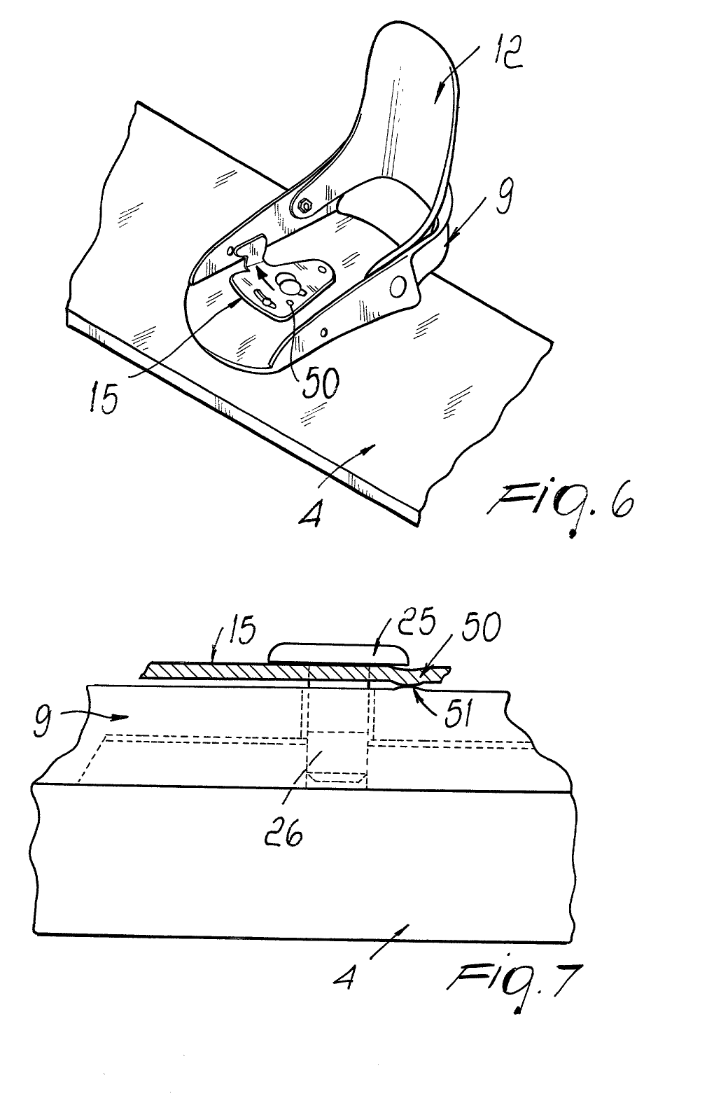

For example, FIGS. 6 and 7 illustrate a solution which provides, on the adjustment plate, a stud or an inclined plane, designated by the reference numeral 50, which interacts, in the locking position, with a complementarily shaped inclined plane 51 provided on the base.

The purpose of this refinement is to tension the central screw in order to allow free movement in the disengagement stroke.

The materials used and the dimensions that constitute the individual components of the invention may of course be more pertinent according to specific requirements.

The disclosures in Italian Patent Application No. TV99A000139 from which this application claims priority are incorporated herein by reference.

What is claimed is:

1. An angular adjustment device particularly for a snowboard binding, comprising a toothed disk which is rigidly connected to said snowboard and a supporting base for a shoe, comprises a plate which is slidingly associated with said base and selectively interacts with means for connection to said toothed disk which allow the connection or disconnection of said toothed disk with respect to a complementarily toothed seat formed below said base.

2. The device according to claim 1, wherein said toothed disk has a first hole which is in a central position and a lateral edge which is toothed and inclined upward, and wherein said plate, arranged in a central region of said base, is flat and has, on one side, a tab which protrudes vertically upward.

3. The device according to claim 2, wherein said plate, which is triangular, is rotatably connected to said base at the vertex which is advantageously directed toward the rear part of said base by means of a second screw whose stem is threaded at an adapted second hole formed in said plate.

4. The device according to claim 3, wherein said plate has, in the opposite direction with respect to said second hole, a second slot which is shaped like a circular arc which is centered at said second hole.

5. The device according to claim 4, wherein a sliding pin is arranged in said second slot and is fixed at one end to said base, so as to constitute, together with said second slot, a sliding guide for the partial rotation of said plate with respect to said base.

6. The device according to claim 5, wherein said plate has an opening which is shaped appropriately so as to have a third slot and a connected third hole which is arranged toward said tab.

7. The device according to claim 6, wherein said connection means, constituted by a third screw which selectively interacts with said plate, can be arranged in said opening.

8. The device according to claim 7, wherein said third screw has a head whose dimensions are such that it can pass through said third hole of said opening and a stem whose diameter allows it to slide within said third slot.

9. The device according to claim 8, wherein the tip of said stem of said third screw is detachably connected to said hole formed in said toothed disk.

10. The device according to claim 1, wherein the position of said plate discriminates the connection, or lack thereof, of said lateral edge of said toothed disk with a complementarily toothed seat formed below said base in a region below said plate.

11. The device according to claim 9, wherein the distance between said head and the upper surface of said toothed disk is approximately equal to the sum of the thicknesses of said plate and of said base at said seat.

12. The device according to claim 1, wherein the uncoupling of said toothed disk from said complementarily toothed seat is conveniently achieved with a vertical movement which is not greater than the height of said plate.

13. The device according to claim 3, wherein said plate has an opening which is located in an intermediate position between said second hole and said second slot, said opening being appropriately shaped so as to have a third slot, which is shaped like a circular arc which also is centered proximate to said second hole, and a connected third hole, which is located toward said tab.

14. The device according to claim 1, wherein said plate is rotatably connected to said base at the vertex that is advantageously directed toward the front part of said base, said rotary connection being achieved by means of a second screw whose stem is associated at an adapted second hole formed in said plate.

15. The device according to claim 1, wherein said plate is associated with said base so that it can slide with respect to said base with a translatory motion.

16. The device according to claim 1, wherein said plate is associated with said base so that it can slide with respect to said base with a longitudinal or transverse translatory motion.

17. The device according to claim 1, wherein on said plate there is a stud or an inclined plane which interacts, in the locking position, with a complementarily shaped inclined plane or stud provided on said base.
